(19) United States
(12) Patent Application Publication
(10) Pub. No.: US 2006/0084407 A1
(43) Pub. Date: Apr. 20, 2006

(54) POWER MANAGEMENT METHOD FOR REDUCING DATA TRANSMISSION ERROR

(76) Inventor: Huan-Ding Li, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,953

(22) Filed: Aug. 24, 2005

(30) Foreign Application Priority Data
Sep. 30, 2004 (TW) 93129538

(51) Int. Cl. H04B 1/16

(52) U.S. Cl. 455/343.1; 455/574

(57) ABSTRACT

A power management method for reducing data transmission errors is applicable in a mobile phone to be executed before the mobile phone enters into in a power-saving mode. The method comprises the following steps. First, whether transmitted data is accessed by a data transmission mechanism during the period of a counting time is checked. If no transmitted data being accessed is found during this period, the mobile phone will enter into power-saving mode.

### CROSS-REFERENCE TO RELATED APPLICATION

This application claims the priority benefit of Taiwan application serial no. 93129538, filed on Sep. 30, 2004. All disclosure of the Taiwan application is incorporated herein by reference.

### BACKGROUND OF THE INVENTION

1. Field of the Invention

The present invention relates to a power management method, and more particularly, to a power management method for reducing data transmission errors by using GPRS data transmission.

2. Description of the Related Art

General Packet Radio Service (GPRS) is a communication technique developed by European Telecommunications Standards Institute. Based on Global System for Mobiles (GSM), GPRS can transmit 100 KB data packets and is ten times faster than the present communication system (circuit switching technology), and has the similar functions of virtual network. By using GSM network structure, GPRS provides Datacomm technology so that users can access internet with higher speed or execute relevant mobile data functions. GPRS is designed for transmitting massive data in a very short period of time, such as in global data network or for e-mail transmission. Most of the time, the application program of GPRS is idle; once starting running, it is desired to complete accessing massive information in a shortest period of time.

To be compatible with the present GSM network, the wireless interface of GPRS uses timeslots which were originally used for voice transmission to transmit data. The reason why GPRS provides a higher data transmission speed is merely using combination of 2-8 timeslots and re-allocating the timeslots and channels of GSM so the transmission speed at the wireless interface can be improved. In addition, GPRS uses packet switching, rather than switching circuits, to provide efficient data transmission routes. As a result, during the time period of transmission, most of the wireless channel sources of the base stations will be reserved to serve data transmission.

Since GPRS is effective in transmitting massive data, most of cellular phones currently use GPRS for massive information exchange. The prior art technology, however, has some problems. For example, if the mobile phones are in a power-saving mode, such as a sleep mode, errors may occur and accurate information can not be obtained if the mobile phones are using GPRS to access information.

### SUMMARY OF THE INVENTION

Accordingly, the present invention is directed to a power management method for reducing data transmission errors. For example, when the access point of the mobile phone is in a power-saving mode, errors created in data transmission can be substantially reduced.

The present invention provides a power management method for reducing data transmission errors. The method is adapted for a mobile phone and executed before the mobile phone enters into a power-saving mode. The present invention comprises the following steps. First, whether a transmitted data is accessed by a data transmission mechanism during a counting time is checked. If the transmitted data is not accessed during the counting time, the mobile phone will enter into a power-saving mode.

In an embodiment of the present invention, the mobile phone performs the following steps during the counting time. First, the counting time is counted backwards. It is checked whether the transmitted data is being accessed. If the transmitted data is not accessed, it should be checked whether the counting time is equal to 0. If the counting time is not equal to 0, it should continue checking whether the transmitted data is being accessed. When the counting time is equal to 0, the mobile phone will enter into a power-saving mode.

In addition, when the transmitted data is being accessed during the counting time, the counting time will be reset and be re-counted backwards to repeatedly check whether the transmitted data is accessed.

Under a preferred situation, the transmission mechanism described above is a General Packet Radio Service (GPRS).

In addition, the mobile phone referred in the present invention includes smart phone.

In another aspect, the present invention provides a power management method for reducing data transmission errors, which can also be used for an access point in a wireless network. The method of the present invention comprises the following steps. When it is determined that the access point should enter into a power-saving mode, a counting time is counted backwards. Monitoring that the transmitted data is being accessed during the counting time is checked. When the transmitted data is not accessed during the counting time, the access point will enter into a power-saving mode.

In an embodiment of the present invention, the wireless network includes a GPRS network, and the access point includes a mobile phone.

In addition, as mentioned, checking whether the transmitted data is accessed may comprise the following steps. During the countdown of the counting time, whether the transmitted data is being accessed is checked. When the transmitted data is not be accessed, whether the counting time is equal to 0 should be checked. When the counting time is not equal to 0, it should continue checking whether the transmitted data is being accessed. When the counting time is equal to 0, the mobile phone will enter into a power-saving mode.

Accordingly, the present invention monitors whether the transmitted data is accessed during a counting time before the mobile phone enters a power-saving mode. If the transmitted data is being accessed, the mobile phone will not enter the power-saving mode. Therefore, the present invention can prevent data transmission errors caused while accessing operation when the mobile phone is in the power-saving mode.

The above and other features of the present invention will be better understood from the following detailed description of the preferred embodiment of the invention that is provided with the accompanying drawings.

### BRIEF DESCRIPTION OF THE DRAWINGS

FIG. 1A is a schematic drawing showing a model of a wireless network.

FIG. 1B is a schematic drawing showing an integration of data and audio-visual source.

FIG. 2 is a schematic drawing showing a structure of GPRS.

FIG. 3 is a block diagram showing an internal structure of a mobile phone according to an embodiment of the present invention.

FIG. 4 is a flowchart showing a power management method for reducing data transmission errors according to an embodiment of the present invention.

### DESCRIPTION OF SOME EMBODIMENTS

### First Embodiment

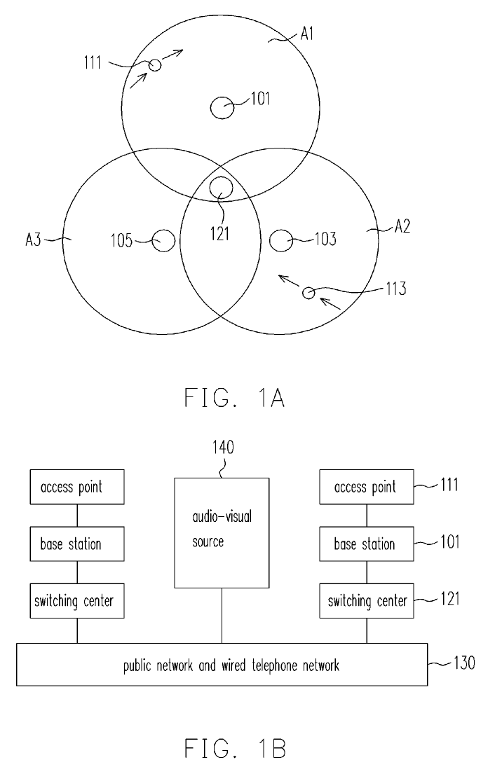

FIG. 1A is a schematic drawing showing a model of a wireless network. Referring to FIG. 1A, the model of the wireless network comprises base stations 101, 103 and 105; access points 111 and 113; and a switching center 121. Wherein, each of the base stations serves a specified region. For example, the base station 101 serves the region A1. Generally, a region served by the base station is called a cell.

In addition, the access points, as 111 and 113, represent a user's wireless terminal equipment, such as a mobile phone, in the wireless network. The switching center 121 among the cells A1, A2 and A3 connects to the base stations, or to public networks, such as internet, and wired telephone networks, such as public switched telephone network (PSTN).

FIG. 1B is a schematic drawing showing an integration of data and audio-visual source. Referring to FIGS. 1A and 1B, the switching center 121 transmits the audio-visual source 140 to the access point 111 through the base station 101 by connecting to the public network and the wired telephone network 130. The access point 111 is not fixed at a certain location and will be changed by the user's location. If the access point 111 moves from the cell A1 to the cell A2, the switching center 121 will transmit data to the access point 111 by immediately switching the data transmission source from the base station 101 to the base station 103. The switch, however, will not affect communication qualities.

In the present mobile communication technology, since the GPRS can transmit massive data, such as audio-visual data transmission, it becomes the main trend for mobile communication.

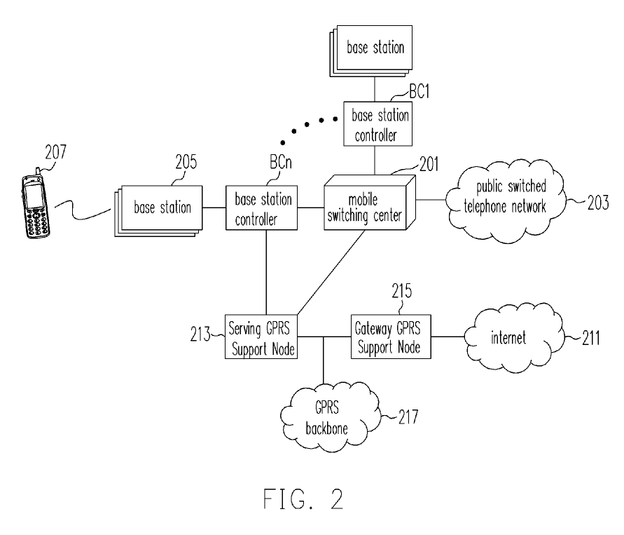

FIG. 2 is a schematic drawing showing a structure of GPRS. Referring to FIG. 2, GPRS is a technique using the Globe System for Mobile Communication (GSM) network as its main structure. The major expansion is software upgrades. Thus, manufacturers are not required to invest a lot of money for hardware expansion.

In the GPRS network of FIG. 2, the mobile switching center 201 connects plural base station controllers BC1-BCn to the wired telephone network, such as PSTN 203. Each of the base station controllers controls, for example, several base stations 205 so that the access point of a mobile phone 207 can link to the PSTN 203 regardless of its location.

When the user wants to use the access point of the mobile phone 207 to access internet, at first the mobile phone 207 sends out a packet data protocol (PDP) context request to the Serving GPRS Support Node (SGSN) 213 by the corresponding base station controller BCn via the base station 205. The SGSN 213 will investigate the status of the access point of the mobile phone 207. Then the SGSN 213 notifies the Gateway GPRS Support Node (GGSN) 215 how to contact with the mobile phone 207, and at the same time establishes the connection with the GGSN 215. The GGSN 215 contacts the Remote Access Dial-in User Service (RADIUS) to acquire the IP address of the mobile phone 207. The GGSN 215 then transmits the IP address to the mobile phone 207 so that the user may be linked to the internet 211 or the GPRS backbone 217 through the mobile phone 207.

Though the present invention is directed to solve the problem in GPRS transmission, it should not be restricted that the present invention can not be applied to other transmission mechanism. One of ordinary skill in the art will understand that different data transmission methods will not affect the spirit of the present invention.

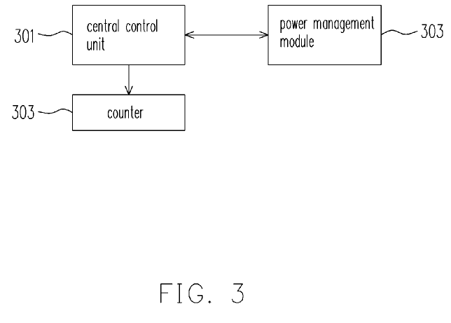

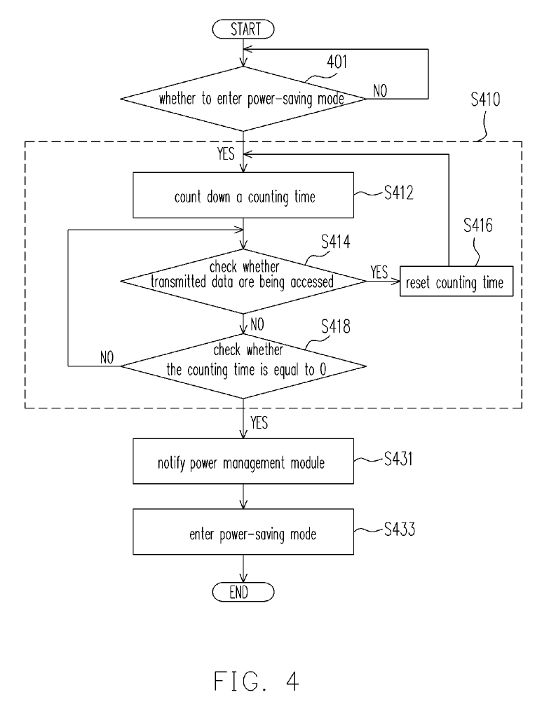

FIG. 3 is a block diagram showing an internal structure of a mobile phone according to an embodiment of the present invention. FIG. 4 is a flowchart showing a power management method for reducing data transmission errors according to an embodiment of the present invention. Referring to FIGS. 3 and 4, in order for one of ordinary skill in the art to understand the spirit of the present invention, the following is an embodiment regarding a mobile phone to make the invention more illustrative. The mobile phone comprises a central control unit 301, which controls peripheral chips, such as the power management module 303.

Referring to FIGS. 3 and 4, when the mobile phone is on, the central control unit 301 keeps checking whether to enable the mobile phone into a power-saving mode, such as a sleep mode (step S401). When the central control unit 301 determines that the mobile phone should enter into power-saving mode, (i.e., “YES” shown in step S401), as presented in step S410, whether the transmitted data is being accessed in the mobile phone by, for example, the GPRS transmission mechanism during the counting time is checked. During the period of the counting time, when determining that the transmitted data is not accessed in the mobile phone, the central control unit 301 notifies the power management module 303 (step S431). The mobile phone then enters into power-saving mode (step S433).

In detail, when determining that the mobile phone should enter into power-saving mode, at first the central control unit 301 controls the counter 302 to count backward a counting time. Then, as shown in step S414, whether the transmitted data is being accessed is checked. If the transmitted data is being accessed in the mobile phone, (i.e., “YES” in step S414), the central control unit 301 performs S416, in which the counter 302 resets the counting time, so as to repeat step S412 until the data transmission is complete. If, in step S414, the transmitted data is not accessed in the mobile phone, (i.e., “NO” in step S414) the central control unit 301 checks, as described in step S418, whether the counting time is equal to 0. If the counting time is not equal to 0, (i.e., “NO” in step S418) the central control unit 301 repeats step S414. If the counting time is equal to 0, (i.e., “YES” in step S418) the central control unit 301 starts performing step S431.

The mobile phone exemplified in the embodiment also includes Smart Phone.

The present invention checks whether the transmitted data is accessed during a counting time before the mobile phone enters the power-saving mode. The access point will not enter power-saving mode until the transmitted data is not accessed. Accordingly, the present invention can prevent errors occurring during data transmission.

Although the present invention has been described with reference to a particular embodiment, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A power management method for reducing data transmission error, the method being executed in a mobile phone before the mobile phone enters into a power-saving mode, comprising the following steps:
checking whether a transmitted data is accessed by a data transmission mechanism during a counting time; and
enabling the mobile phone to enter into the power-saving mode when the transmitted data is not accessed during the counting time.

2. The power management method for reducing data transmission errors of claim 1, wherein, during the counting time, the mobile phone performs the following steps:
counting down the counting time;
checking whether the transmitted data is accessed;
checking whether the counting time is equal to 0 when the transmitted data is not accessed;
checking whether the transmitted data is being accessed when the counting time is not equal to 0; and
entering into the power-saving mode when the counting time is equal to 0.

3. The power management method for reducing data transmission errors of claim 2, wherein when the transmitted data is being accessed during the counting time, the counting time is reset to be recounting down for repeatedly checking whether the transmitted data is accessed.

4. The power management method for reducing data transmission errors of claim 1, wherein the transmission mechanism is General Packet Radio Service (GPRS).

5. The power management method for reducing data transmission errors of claim 1, wherein the mobile phone is a smart phone.

6. A power management method for reducing data transmission error, the method being adapted for an access point in a wireless network, comprising the following steps:
counting down a counting time when the access point is determined to enter into a power-saving mode;
checking whether a transmitted data is accessed during the counting time; and
entering the power-saving mode when the transmitted data is not accessed during the counting time.

7. The power management method for reducing data transmission errors of claim 6, wherein the transmission mechanism is General Packet Radio Service (GPRS).

8. The power management method for reducing data transmission errors of claim 6, wherein the step of checking whether the transmitted data is accessed comprises the following steps:
checking whether the transmitted data is being accessed while counting down the counting time;
checking whether the counting time is equal to 0 when the transmitted data is not accessed;
checking whether the transmitted data is being accessed continually when the counting time is not equal to 0; and
entering the power-saving mode when the counting time is equal to 0.

9. The power management method for reducing data transmission errors of claim 8, wherein when the transmitted data is being accessed during the counting time, the counting time is reset to be recounting down for repeatedly checking whether the transmitted data is accessed.

10. The power management method for reducing data transmission errors of claim 6, wherein the access point includes a mobile phone.

11. A power management method for reducing data transmission error, the method being executed in a mobile phone before the mobile phone enters into a power-saving mode, comprising the following steps:
checking whether a transmitted data is accessed by a data transmission mechanism during a counting time;
enabling the mobile phone to enter into the power-saving mode when the transmitted data is not accessed during the counting time;
wherein during the counting time the mobile phone further performs the following steps:
counting down the counting time;
checking whether the transmitted data is accessed;
checking whether the counting time is equal to 0 when the transmitted data is not accessed;
checking whether the transmitted data is being accessed when the counting time is not equal to 0; and
entering into the power-saving mode when the counting time is equal to 0.

12. The power management method for reducing data transmission errors of claim 11, wherein when the transmitted data is being accessed during the counting time, the counting time is reset to be recounting down for repeatedly checking whether the transmitted data is accessed.

13. The power management method for reducing data transmission errors of claim 11, wherein the transmission mechanism is General Packet Radio Service (GPRS).

14. The power management method for reducing data transmission errors of claim 11, wherein the mobile phone is a smart phone.
